(19) United States
(12) Patent Application Publication
(10) Pub. No.: US 2009/0271966 A1
(43) Pub. Date: Nov. 5, 2009

(54) SHEAR COUPLING ASSEMBLY WITH BACKOFF PREVENTION

(75) Inventors: Benjamin J. Fotty, Edmonton (CA); Benny B. Wolodko, Edmonton (CA)

Correspondence Address: (Weatherford) Wong Cabello Lutsch Rutherford &;Brucculeri LLP, 20333 Tomball Parkway, 6th floor, Houston, TX, 77070, US

(73) Assignee: WEATHERFORD/LAMB, INC., Houston, TX (US)

(21) Appl. No.: 12/112,038

(22) Filed: Apr. 30, 2008

(51) Int. Cl. F16D 9/00

(52) U.S. Cl. 29/428; 464/32

(57) ABSTRACT

A shear coupling assembly utilizes a novel pin coupling member having radial slots formed about a top portion of the insert member, the top portion being radially expandable once engaged in the box coupling member to lockingly engage the threaded connection. Locking of the insert member in the box coupling member prevents backing-off of the connection and maintains a pretension in the neck of the pin coupling member, during use. The top portion of the insert can be radially expanded by forcing a ball bearing into a counterbore formed in the insert member.

### FIELD OF THE INVENTION

Embodiments of the invention relate to a shear coupling assembly used for connecting a downhole pump to a terminal end of an actuating rod string in reciprocating pumped wells, and more particularly to a shear coupling having means for substantially preventing back-off of a threaded connection therebetween.

### BACKGROUND OF THE INVENTION

Downhole reciprocating pumps are positioned and actuated in a wellbore by a rod string extending from surface. The rod string is typically either one continuous member or a plurality of sucker rods, connected end-to-end through standard threaded couplings.

It is known that downhole pumps may become lodged or stuck in a wellbore, often by sand deposited and packed around the pump, either at the downhole pumping location or as the pump is being tripped out of the wellbore. Conventionally, the rod string is removed from the pump by applying a pulling force on the rod string to sever the rod string from the pump.

A shear coupling assembly is typically used to connect between the pump and a downhole end of the rod string. The shear coupling primarily functions to provide a means for separating the rod string from the pump so as to release and remove the rod string from the wellbore and permit specialized equipment to be inserted into the well annulus to free the pump. Use of the shear coupling at the interface between the rod string and the pump provides a specified location at which the pump and rod string are separated and the shear coupling can be constructed to actuate under a desired design load which is highly predictable. Without the shear coupling, the rod string would sever at a location along the rod string that is unknown and largely unpredictable and which can be problematic for retrieval of the pump.

It is known to use a shear coupling comprising transversely extending shear pins for joining male and female coupling members between the pump and the rod string. The shear pins are known to be prone to premature fatigue which arises from cyclic compressive stress induced in the shear pins if the rod string “taps down” at the base of each reciprocating stroke. Further, as the shear pins break, fragments fall downhole into the pump, resulting in further problems in freeing the pump.

In an effort to solve the problems associated with previous shear coupling designs, shear couplings, such as taught in Canadian Patent 1298715 to Mann et al, are known to utilize a threaded connection between a pin coupling member, having an externally threaded head, and an internally threaded box coupling member. Either of the pin coupling member or the internally threaded box coupling member is connected to the pump and the other is connected to the downhole end of the rod string. The threaded head of the pin coupling member threadedly engages the internal bore of the internally threaded coupling member for operatively connecting therebetween. The pin coupling member further comprised a shear neck of reduced diameter between the head and a body of the pin coupling member which is designed to shear under design load to free the pump from the rod string.

In operation, a pretension is applied to the neck of the pin coupling member during threaded connection to the box coupling. The box coupling seats on a shoulder of the pin coupling so as to maintain the neck in tension during normal operation of the pump for preventing premature fatigue of the shear neck.

One major problem associated with such threaded connections is “backing off” of the threads due to operation and vibration of the well equipment resulting in subsequent loosening of the threaded connection and a loss of the pretension in the shear neck. Once the pretension is lost, premature failure of the shear coupling is highly imminent as the reduced diameter neck becomes exposed to cyclic compressive stresses associated with the rod string “tapping down” at the bottom of each downstroke, impact loading associated with the “fluid pound” phenomenon and bending stresses associated with flexure of the rod string. Due to the coarse nature of the threads used in the connection, the pretension can be lost with a turn in the connection of less than 180 degrees.

Conventionally, thread-locking adhesive or epoxy such as LOCTITE® (available from Henkel Technologies, USA) has been used to strengthen the threaded connection between the coupling members. However, degradation of the thread-locking epoxy often results from prolonged exposure to elevated temperatures and chemical compounds, such as pentanes and hexanes, found in the well environment. Further, machining oil residues on the connecting threads may prevent proper adhesion of the epoxy to the metal threads. Additionally, if the epoxy does not evenly fill the crevices in the thread pattern, an inconsistent bonding may develop between the threaded surfaces resulting in a weaker bond.

Therefore, there is interest in the industry for a shear coupling assembly and a method of connection therein which provides a reliable locking mechanism for permanently locking the connecting threads in place to prevent backing-off and ensuring maintenance of the pretension which is applied to the neck of the shear coupling during assembly.

### SUMMARY OF THE INVENTION

An improved pin coupling member for a shear coupling assembly comprises discontinuities formed in a top portion of an insert member of the pin coupling member which permit the top portion of the insert member to be expanded radially outward after operative engagement with a box coupling member so as to lockingly engage the threaded connection therebetween to prevent backing-off of the connection. Thus, pretension applied to a neck of the pin coupling member during operative engagement with the box coupling member is maintained during use.

In one broad aspect of the invention, a pin coupling member for a shear coupling assembly adapted for connecting a downhole pump to a downhole end of a rod string, the pin coupling member comprises: a cylindrical body; a cylindrical insert member extending axially outwardly from the cylindrical body and having an externally threaded surface adapted to engage an internally threaded axial bore of a box coupling member; a shear neck connecting between the cylindrical body and the insert member; a counterbore formed in the insert member; and two or more radial discontinuities formed in a top portion of the insert member being of sufficient axial depth for permitting the top of the insert member to flex radially outwardly in response to a force applied to the counterbore for lockingly engaging the threaded connection between the pin coupling member and the box coupling member.

In another broad aspect of the invention, a shear coupling assembly adapted for connecting between a downhole pump and a downhole end of a rod string, comprises: a box coupling member having a tubular body; and an internally threaded axial bore formed therethrough; and a pin coupling member having a cylindrical body; a cylindrical insert member extending axially outwardly from the cylindrical body and having an externally threaded surface for engaging the internally threaded axial bore of the box coupling member; a shear neck connecting between the cylindrical body and the insert member; a counterbore formed in the insert member; and two or more radial discontinuities formed in a top portion of the insert member and being of sufficient depth for permitting radially outward flexing of the top portion in response to a force applied to the counterbore for lockingly engaging the threaded connection between the pin coupling member and the box coupling member.

In another broad aspect of the invention, a method of assembling a shear coupling assembly comprises: threading an insert member of a pin coupling member into a threaded axial bore of a box coupling member, the insert member having a counterbore and two or more radial discontinuities formed therein at a top portion for permitting outward radial expansion of the top portion; applying pretension to a neck of the pin coupling member during the threading of the box coupling member to seat on the pin coupling member and extending axially between a cylindrical body of the pin coupling assembly and the insert member; and thereafter inserting an expansion member into the counterbore for expanding the top portion of the insert member radially outward within the axial bore of the box coupling member for lockingly engaging the threaded connection therebetween.

### BRIEF DESCRIPTION OF THE DRAWINGS

FIG. 1 is a sectional side view of a prior art shear coupling assembly;

FIG. 2 is a partial sectional side view of an alternate embodiment of the prior art shear coupling assembly of FIG. 1;

FIG. 3A is an exploded perspective view of a shear coupling assembly according to an embodiment of the invention;

FIG. 3B is a side view of an assembled shear coupling assembly according to FIG. 3A;

FIG. 4 is a plan view of the pin coupling member according to FIG. 3A;

FIG. 5 is a side view of the pin coupling member according to FIG. 3A;

FIG. 6 is a 90 degree rotated side view of the pin coupling member according to FIG. 5;

FIG. 7 is a longitudinal sectional view of the assembled shear coupling according to FIG. 3A, along section lines A-A of FIG. 4, after insertion of an expansion member;

FIG. 8 is a longitudinal sectional view of the assembled shear coupling according to FIG. 3A, along section lines B-B of FIG. 4, after insertion of an expansion member;

FIGS. 9A-9E are plan views of the pin coupling member illustrating alternate slot patterns in a top of an insert portion; and

FIGS. 10A-10C are side views of expansion members according to embodiments of the invention.

### DETAILED DESCRIPTION OF THE PREFERRED EMBODIMENT

Embodiments of the invention relate to improvements to prior art shear coupling assemblies to substantially prevent backing-off of a threaded connection within the shear coupling assembly when in use. The improvements are described in the context of a conventional shear coupling assembly having a male and a female member threadedly connected therebetween. A description of the conventional shear coupling assembly and method of assembly is provided to assist in understanding the embodiments of the invention.

### Prior Art Shear Coupling Assembly

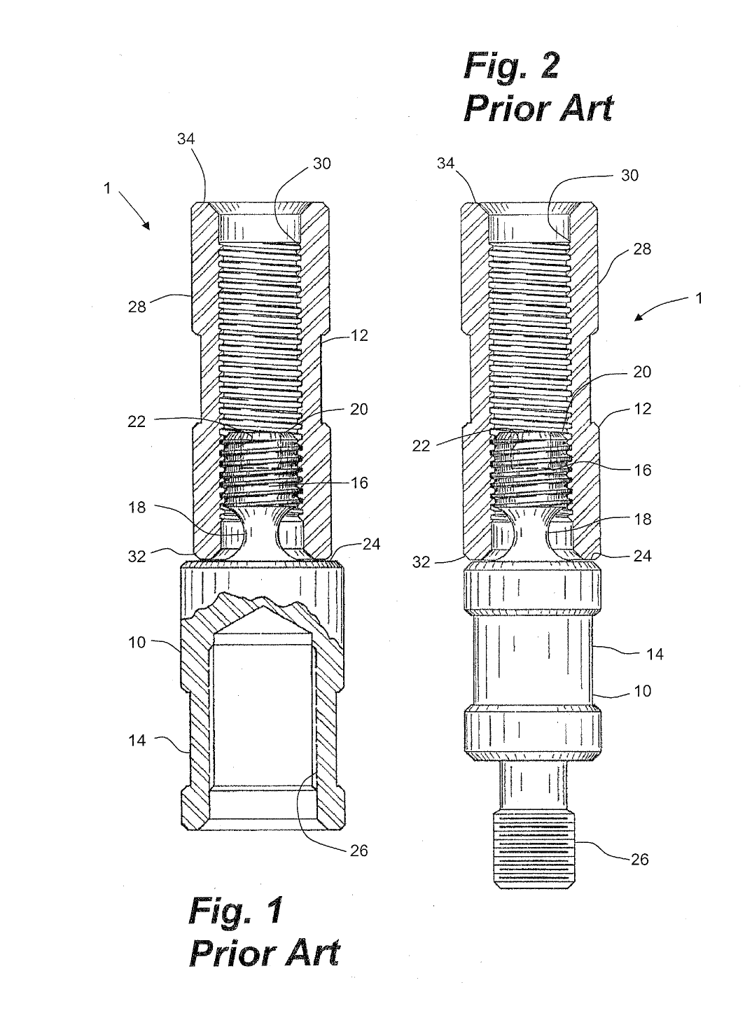

Having reference to FIGS. 1 and 2, a conventional prior art shear coupling assembly 1 comprises two members, a pin coupling member 10 and a box coupling member 12. Either of the pin or box coupling member 10, 12 can be connected to either of a pump or a rod string (not shown) for permitting connection therebetween.

The pin coupling member 10 comprises a cylindrical body 14 having an externally threaded insert member 16 extending axially outwardly therefrom and connected to the body 14 by a shear neck 18 typically having a relatively reduced section. The insert member 16 is cylindrical and smaller in diameter than the cylindrical body 14. The reduced section of the shear neck 18 has a known cross-sectional area and acts as a preferential point of parting in the connection between the rod string and the pump under design loading. A top 20 of the insert member 16 is bored with an internally threaded axial counterbore 22 adapted for use for pretensioning the neck 18 during assembly, as described below. The pretension in the neck 18 is maintained through a seating interface between the pin and box coupling members 10, 12 along a radial contact shoulder 24 formed at a top of the cylindrical body 14. The body 14 further comprises a threaded connection 26 at an end opposite the insert member 16 for threaded connection to either the rod string or the pump and can be either a female connection (FIG. 1) or a male connection (FIG. 2) as shown.

The box coupling member 12 comprises a tubular body 28 having an internal threaded axial bore 30 that co-operates with a thread profile of the externally threaded insert member 16 and which extends substantially a full length of the bore 30. A first end 32 of the tubular body 28 is connected to the pin coupling member 10 at the externally threaded insert member 16. A second end 34 of the body tubular body 28 is threadedly connected to either the rod string or the pump.

### Prior Art Method of Assembly

Prior to assembling the pin and box coupling members 10,12, a thread-locking epoxy or adhesive is typically applied to the externally threaded insert 16 and the radial contact shoulder 24 of the pin coupling member 10. The externally threaded insert 16 is inserted into either the first or second end 32, 34 of the box coupling member 12 and is advanced along the internally threaded axial bore 30 until the radial contact shoulder 24 of the pin coupling member 10 approaches, but does not yet fully contact, the first or second end 32,34 of the box coupling's tubular body 28.

A tensioning rod commonly called a ready rod or bolt (not shown), having an external thread at one end matching the profile of the internally threaded counterbore 22, is inserted through the axial bore 30 of the box coupling member 12 and is threaded into the internally threaded counterbore 22. The shear neck 18 is placed into tension by pulling upwardly on the tensioning rod. With the tensioning rod and shear neck 18 under tension, the box coupling member body 12 is further advanced along the externally threaded insert 16 until the tubular body 28 firmly contacts the radial contact shoulder 24 of the pin coupling member 10. Contact between the tubular body 28 of the box coupling member 12 and the radial contact shoulder 24 of the pin coupling member 10 acts to maintain the pretension in the neck 18. The tensile load on the tensioning rod is then released and the tensioning rod is unthreaded and removed from the assembly 1. The assembled shear coupling 1 is unused for sufficient time to permit the thread-locking epoxy to dry and harden.

### Embodiments of the Invention

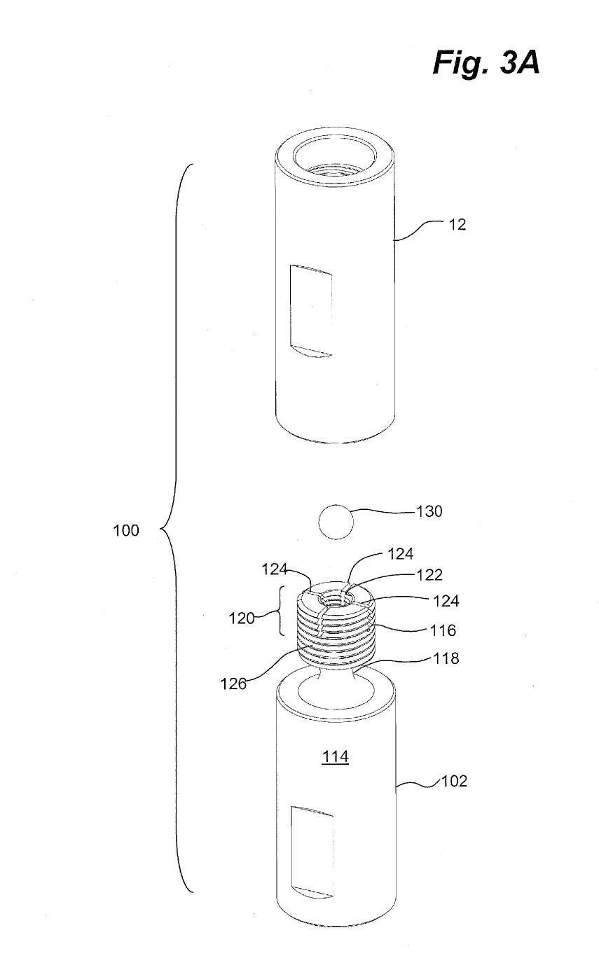

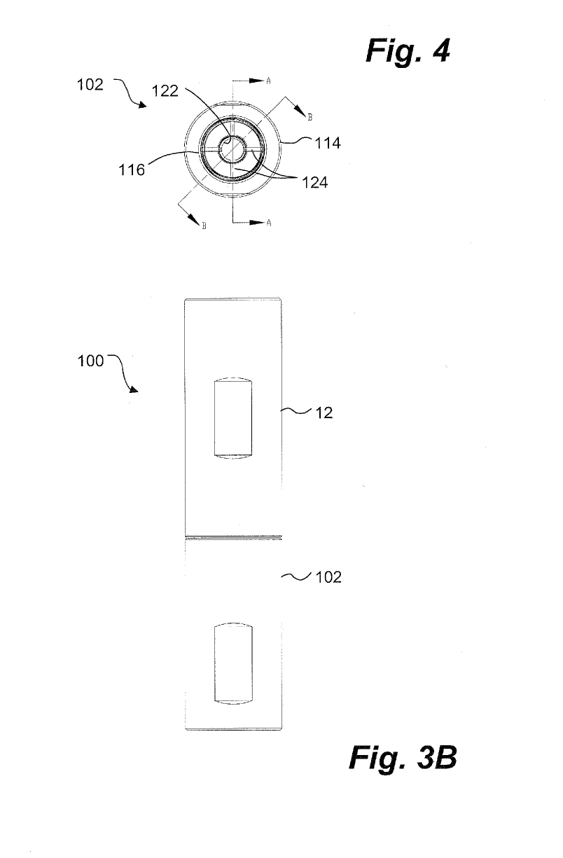

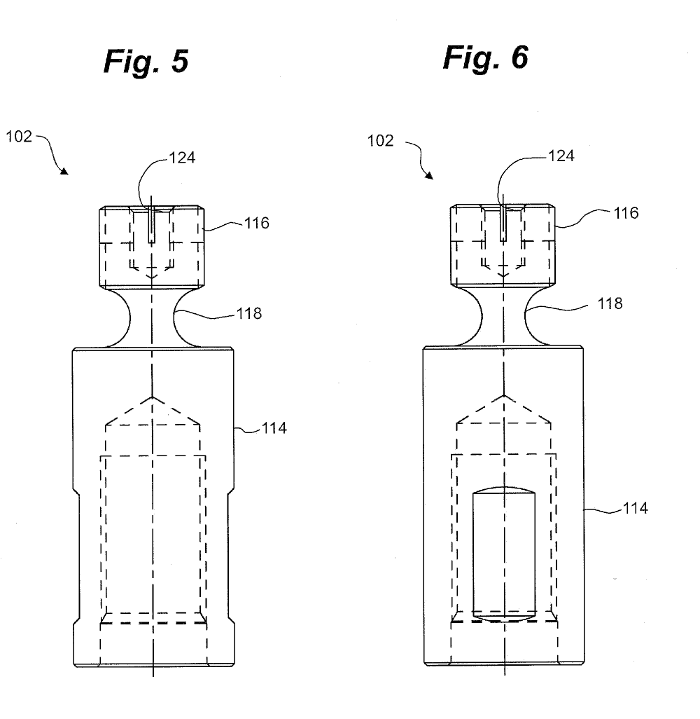

Having reference to FIGS. 3A-6 and in an embodiment of the invention, a shear coupling assembly 100 utilizes an improved pin coupling member 102.

The pin coupling member 102, as in the prior art, comprises a cylindrical body 114 having an externally threaded insert member 116 extending axially outwardly therefrom and connected to the body 114 by a shear neck 118 designed to part under design loads. In the embodiment shown herein, the shear neck 118 has a reduced section. While referred to in the industry as a shear neck, it is believed the parting is a tensile failure. The insert member 116 is bored with an internally threaded axial counterbore 122 used to pretension the neck 118 during assembly, as described for the prior art shear coupling assembly 1.

In embodiments of the invention, a top portion 120 of the insert member 116 comprises two or more radial discontinuities 124, such as slots or grooves, formed radially across a radius of the top portion 120 of the insert member 116, from an outer threaded surface 126 of the insert member 116 to join the internally threaded axial counterbore 122. The radial discontinuities 124 extend axially into the insert member 116 sufficiently to permit radially outward flexing of at least the top portion 120 thereof.

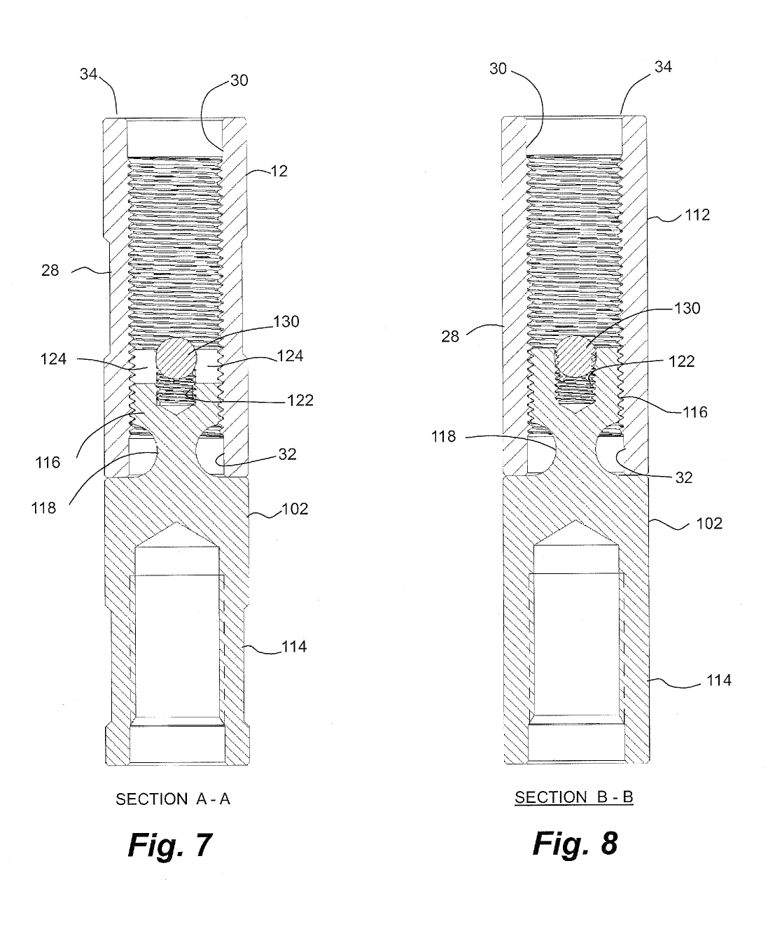

As shown in FIGS. 7 and 8, the improved pin coupling member 100 is threadedly connected to the inner threaded surface 129 of the box coupling member 12 as described for the prior art shear coupling assembly 1.

After release and removal of the tensioning rod from the insert after pretensioning of the neck 118, the insert member 116 is locked to the box coupling member 12. An expansion member 130, such as a ball or a wedge or the like, is positioned at an opening 132 of the internally threaded axial counterbore 122 of the insert member 116. Pressure is applied downwardly to the expansion member 130 to move the expansion member 130 into the counterbore 122 sufficient to flex the top portion 120 of the insert 116 radially outwardly. The outer threaded surface 126 of the insert member 116 is caused to more strongly engage or lock with the inner threaded surface 129 of the box coupling member 12, substantially preventing backing-off of the threaded connection during use. Applicant believes that local deformation of the co-operating threads of the insert member 116 and threaded inner bore 129 of the box coupling member 12 may assist to ensure that the threaded connection cannot loosen during use and further acts to maintain the pretension in the shear neck 118 substantially preventing premature failure of the shear neck 118.

In an embodiment of the invention, best seen in FIGS. 3A, 7 and 8, the expansion member 130 is a sphere, such as a ball bearing, which has a diameter slightly larger than a major diameter of the internal thread of the insert's counterbore 122.

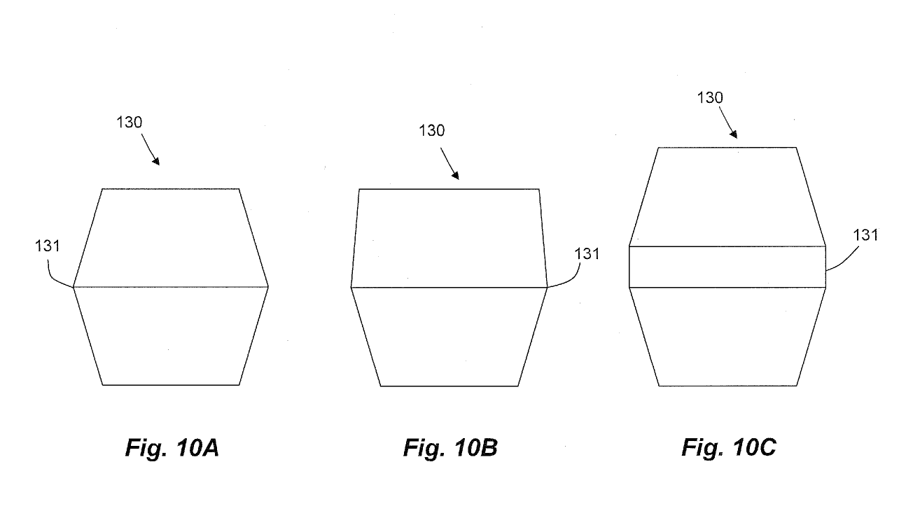

Alternately, as shown in FIGS. 10A-C, the expansion member 130 is shaped so as to have a greatest extent 131 being slightly larger than the major diameter of the internal thread of the insert's counterbore 122 formed along a length of the expansion member 130.

A chamfer 134 is cut around the opening 132 or upper periphery of the counterbore 122 so as to provide a seat to aid in concentrically positioning the ball bearing 130 prior to the application of downward force thereto and to ease the entry of the ball bearing 130 into the counterbore 122. In an embodiment, force is applied to the ball bearing 130 until a major diameter of the ball bearing 130 is below a top face 121 of the insert 116. In an embodiment, the ball bearing 130 is inserted until a top of the ball bearing 130 is flush with the top face 121 of the insert 116.

In one embodiment, a hydraulic press (not shown) is used to apply force to the ball bearing 130 to force the ball bearing 130 into the counterbore 122.

As shown in FIGS. 4-6 and 9A and in one embodiment, four radial, orthogonal discontinuities or slots 124 are formed about a circumference of the top portion 120 of the insert 116. In this embodiment, the radial slots 124 extend axially to a depth sufficient to permit radial expansion of at least the top portion 120 of the insert 116 upon insertion of the ball bearing 130. In one embodiment the radial slots 124 extend about one half the depth of the insert member 116. Alternately, the radial slots 124 may extend further into the top portion 120 to ensure flexure.

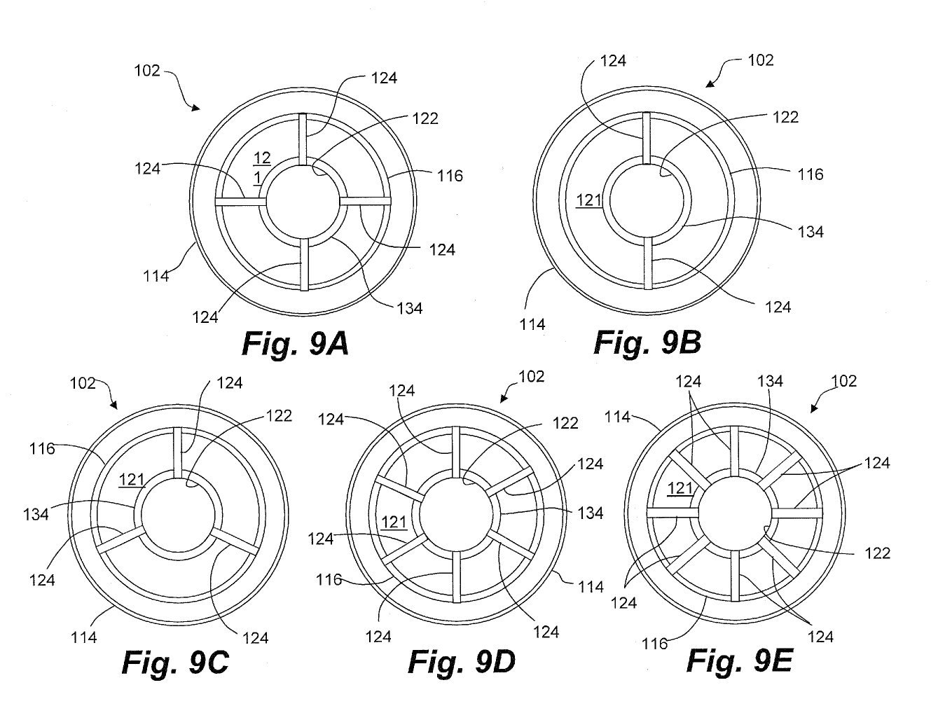

In an embodiment as shown in FIG. 9B, two radial slots 124 are formed at 180 degrees from each other and effectively extend across the diameter of the insert's top portion 120.

In an embodiment as shown in FIG. 9C, three radial slots 124 are spaced evenly about the circumference of the top portion 120 of the insert 116.

In an embodiment as shown in FIG. 9D, six radial slots 124 are spaced evenly about the circumference of the top portion 120 of the insert 116.

In an embodiment as shown in FIG. 9E, eight radial slots 124 are spaced evenly about the circumference of the top portion 120 of the insert 116. Applicant believes that additional slots 124 may be added as required to radially deflect the top portion 120 of the insert member 116.

Diametrically opposed slots 124, formed across the top portion 120 of the insert 116 can aid in the formation of the slots.

### EXAMPLE

In an embodiment of the invention as shown in FIGS. 7 and 8, a shear coupling assembly 100 sized for ¾″ sucker rod, includes both a box coupling member 12 and a pin coupling member 102. The shear coupling assembly 100 is typically manufactured using 4140 AISI, HTSR alloy steel or other suitable structural material. The threaded surfaces for connection to the pump and the sucker rod are standard API threaded connections.

In this embodiment, the total length of the pin coupling member 102 is 4.687″ and the insert member 116 is 0.843″ in length. Four radial, orthogonal slots 124 are cut in the top portion 120 of the insert member 116 of the pin coupling member 102, forming a cross-shaped discontinuity in the top portion 120 of the insert member 116. The slots 124 extend axially about 0.375″ into the insert member 116 and are about 1/16″ to 1/32″ in width. The insert member's counterbore 122 has a diameter of 7/16″ and is threaded using a 7/16″—14 UNC Class 2B thread at an effective depth of ⅝″. The chamfer 134 formed at the opening 132 of the counterbore 122 is at 45°× 1/16″.

The expansion member 130, used to radially expand the discontinuous top portion 120 of the insert member 116, is a ½″ ball bearing 130 made of a high compressive strength material, having a suitable hardness and surface finish.

In operation, the ball bearing 130 is inserted through the axial bore 30 in the box coupling member 12 after the removal of the tensioning rod. The box coupling member 12 is 4.05 inches in length. At a starting depth, a top of the ball bearing 130 resting on the opening 132 of the counterbore 122 of the insert member 116 engaged therein is at about 2.25 inches from the top of box coupling 12. Force is applied to the ball bearing 130, such as using a hydraulic press, to force the ball bearing 130 into the counterbore 122. The travel of the press is about 0.37+0.03 inches to position the major dimension of the ball bearing 130 flush with the top face 121 of the insert member 116. The top of the ball bearing 130 after insertion is at about 2.46 inches from the top of box coupling 12 and about 0.16 inches above the top of the insert member 116.

What is claimed:

1. A pin coupling member for a shear coupling assembly adapted for connecting a downhole pump to a downhole end of a rod string, the pin coupling member comprising:
a cylindrical body;
a cylindrical insert member extending axially outwardly from the cylindrical body and having an externally threaded surface adapted to engage an internally threaded axial bore of a box coupling member of the shear coupling assembly;
a shear neck connecting between the cylindrical body and the insert member;
a counterbore formed in the insert member; and
two or more radial discontinuities formed in a top portion of the insert member being of sufficient axial depth for permitting the top of the insert member to flex radially outwardly in response to a substantially radial force applied to the counterbore for lockingly engaging the threaded connection between the pin coupling member and the box coupling member.

2. The pin coupling member of claim 1 wherein the two or more discontinuities are slots.

3. The pin coupling member of claim 1 wherein the two or more radial discontinuities are orthogonal discontinuities spaced about a circumference of the top portion of the insert.

4. The pin coupling member of claim 1 wherein the two or more radial discontinuities are three slots spaced evenly about a circumference of the top portion of the insert member.

5. The pin coupling member of claim 1 wherein the counterbore is adapted to accept an expansion member for applying the force to the counterbore.

6. The pin coupling member of claim 1 wherein the shear neck has a section reduced in cross-section compared to the insert member.

7. A shear coupling assembly adapted for connecting between a downhole pump and a downhole end of a rod string, comprising:
a box coupling member having
a tubular body; and
an internally threaded axial bore formed therethrough; and
a pin coupling member having
a cylindrical body;
a cylindrical insert member extending axially outwardly from the cylindrical body and having an externally threaded surface for engaging the internally threaded axial bore of the box coupling member;
a shear neck connecting between the cylindrical body and the insert member;
a counterbore formed in the insert member; and
two or more radial discontinuities formed in a top portion of the insert member and being of sufficient depth for permitting radially outward flexing of the top portion in response to a force applied to the counterbore for lockingly engaging the threaded connection between the pin coupling member and the box coupling member.

8. The shear coupling assembly of claim 7 further comprising:
an expansion member,
wherein the expansion member forces the top portion radially outward.

9. The shear coupling assembly of claim 8 wherein the expansion member is forced into the counterbore for flexing the top portion radially outward.

10. The shear coupling assembly of claim 8 wherein the expansion member is a sphere having a diameter larger than a diameter of the counterbore.

11. The shear coupling assembly of claim 10 wherein the sphere is a ball bearing.

12. The shear coupling assembly of claim 11 wherein the ball bearing is inserted into the counterbore until a major diameter of the ball bearing is below a top face of the insert member.

13. The shear coupling assembly of claim 8 further comprising a chamfer formed about an opening to the counterbore for easing the expansion member into the counterbore.

14. The shear coupling assembly of claim 7 wherein the two or more radial discontinuities are orthogonal slots spaced about a circumference of the top portion of the insert.

15. The shear coupling assembly of claim 7 wherein the two or more discontinuities are three slots spaced evenly about a circumference of the top portion of the insert member.

16. The shear coupling assembly of claim 7 wherein the shear neck has a section reduced in cross-section compared to the insert member.

17. A method of assembling a shear coupling assembly comprising:
threading an insert member of a pin coupling member into a threaded axial bore of a box coupling member, the insert member having a counterbore and two or more radial discontinuities spaced about a top portion for permitting outward radial expansion of the top portion;
applying pretension to a neck of the pin coupling member during the threading of the box coupling member to seat on the pin coupling member; and thereafter
inserting an expansion member into the counterbore for expanding the top portion of the insert member radially outward within the axial bore of the box coupling member for lockingly engaging the threaded connection therebetween.

18. The method of claim 17 wherein the expansion member is a sphere having a diameter larger than the counterbore, the inserting the expansion member further comprising:
applying a downward force to the sphere for forcing the sphere into the counterbore.

19. The method of claim 17 further comprising:
prior to threading the insert member into the axial bore of the box coupling member,
applying a thread-locking adhesive to the externally threaded insert member.

20. The method of claim 17 wherein the pin coupling member further comprises a radial contact shoulder formed about a top of the cylindrical body further comprising, prior to threading the insert member into the axial bore:
applying a thread-locking adhesive to the externally threaded insert member and the radial contact shoulder; and
threading the insert member into the axial bore of a box coupling member until a bottom of the box coupling member contacts the radial contact shoulder of the pin coupling member.
